(19) United States
(12) Patent Application Publication
(10) Pub. No.: US 2025/0151176 A1
(43) Pub. Date: May 8, 2025

(54) Insulated Cover

(71) Applicant: Chad B. Touchet, Pinehurst, TX (US)

(72) Inventor: Chad B. Touchet, Pinehurst, TX (US)

(21) Appl. No.: 18/500,186

(22) Filed: Nov. 2, 2023

(51) Int. Cl. H05B 3/36; E03B 7/12

(52) U.S. Cl. CPC H05B 3/36; E03B 7/12

(57) ABSTRACT

An insulated cover for an exposed structure comprising a liquid impermeable outer wall, an insulating layer, a heating element, a thermostat, and a power source. The liquid impermeable outer wall can be any waterproof or substantially waterproof material. The purpose of the outer wall is to protect the structure from the elements, i.e. ice, rain, wind, cold, etc. The outer wall can also serve to protect other elements of the insulated cover, such as keeping the battery and/or the heating element dry. A heating element can be used to heat the structure when required. A thermostat can be used to automate the heating process.

### FIELD

The present disclosure generally relates to an insulated and heated cover for outdoor use.

### BACKGROUND

There are often structures in public which are exposed to the elements. In many regions of the world, these structures can be exposed to extreme temperatures. Especially in climates where the temperature drops below freezing, it is desirable to protect and warm these structures.

Exemplary structures include pipes, gauges, sensors, tools, and the like. For example, a homeowner may have swimming pool equipment (or water within that equipment) that should not freeze. Backflow prevention piping, for example, is often exposed and above ground, thereby making it susceptible to freezing.

Many methods are currently used to “winterize” equipment or prevent freezing of fluid within the equipment. Freeze protection valves are often used to help prevent piping from rupturing. Continuous flow of fluid through the structure can help reduce the risk of freezing. Glycol additives to fluids can depress the freezing temperature of the fluid. Piping insulation is often used, but makes access to the pipe for maintenance and repair a difficult issue.

Often, it will be desirable to protect structures in remote locations without frequent visits by personnel or ready access to power. The present disclosure provides a solution which is portable, economical, and efficacious while addressing the drawbacks of currently employed solutions.

### SUMMARY OF THE INVENTION

The present disclosure relates to an insulated and heated cover for outdoor use. The cover requires no maintenance and can provide heat to a structure when necessary.

### BRIEF DESCRIPTION OF THE DRAWINGS

The detailed description will be better understood in conjunction with the accompanying drawings as follows:

FIG. 1 shows profile view of a structure.

FIG. 2 depicts a depicts the insulated cover covering an exposed structure.

FIG. 3 depicts a sectional view of the insulated cover.

FIG. 4 depicts the heating element.

The embodiments of the present disclosure are detailed below with reference to the listed Figures.

### DETAILED DESCRIPTION OF THE EMBODIMENTS

Before explaining the present disclosure in detail, it is to be understood that the present disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to an insulated and heated cover for outdoor use. A typical application for the disclosed apparatus would be to cover and protect backflow prevention piping, which is often exposed above ground. While exemplary uses may be described with respect to backflow prevention piping, it is not intended to be limiting in any fashion.

The term “structure” as used herein refers to exposed piping, fluid conveyance, equipment, valves, gauges, sensors, combinations thereof, and the like. While exemplary embodiments will often be described in relation to exposed piping for fluid transport, this is not intended to be limiting in any manner.

The present disclosure relates to an insulated cover for an exposed structure comprising a liquid impermeable outer wall, an insulating layer, a heating element, a thermostat, and a power source.

The liquid impermeable outer wall can be any waterproof or substantially waterproof materials known to persons having ordinary skill in the art. Commonly used materials include well known plastics and polymers such as polyethylene, polyvinyl chloride, or polypropylene. In addition, a fabric coated with a plastic can be utilized. A typical outer wall can be a polyester material coated with polyvinyl chloride. The purpose of the outer wall is to protect the structure from the elements, i.e. ice, rain, wind, cold, etc. The outer wall can also serve to protect other elements of the insulated cover, such as keeping the battery and/or the heating element dry.

An insulating layer can be utilized in conjunction with the liquid impermeable outer wall. It is desirable for the insulation to be both thermally and electrically insulating. Any insulation known to persons having ordinary skill in the art can be utilized. Exemplary insulation materials include fiberglass, rock wool, mineral wool, cellulose, natural fibers, polystyrene, polyisocyanurate, polyurethane, perlite, cementitious foam, phenolic foam, insulation facings, and the like.

A typical insulating layer can be a polyester batting commonly utilized by persons having ordinary skill in the art for various purposes. It should be noted, however, that the liquid impermeable outer wall can itself also act as the insulating layer in some embodiments, thereby serving a dual purpose.

A heating element can be positioned between the structure and the liquid impermeable outer wall. Any heating element known to persons having ordinary skill in the art can be utilized. A typical heating element can be a copper, aluminum, composite fiber, or similar thermally and electrically conductive material which is attached to the insulating layer or the liquid impermeable outer wall.

The heating element can be a conductive textile, either formed by itself, or by virtue of a conductive, flexible material being stitched into an insulating layer or the liquid impermeable outer wall. A typical conductive textile comprises a substantially non-conductive material which is coated, embedded, or stitched with electrically and thermally conductive materials. Exemplary non-conductive substrate materials include, but are not limited to: cotton, polyester, nylon, and the like. Exemplary electrically and thermally conductive materials include, but are not limited to: carbon, nickel, copper, gold, silver, titanium, poly(3,4-ethylenedioxythiophene) or PEDOT, and the like.

By passing a current through the heating element, heat is generated to warm the structure. A power source, for providing electricity to the heating element can be in mechanical communication with the heating element. Any power source known to persons having ordinary skill in the art can be utilized. A typical power source can be a battery, a solar cell or solar panel, or both a battery and a solar cell or solar panel.

In embodiments, the solar cell or solar panel can be in mechanical communication with a rechargeable battery and used to charge the battery when sunlight is available so that the battery can provide power throughout nighttime. A thermostat can be utilized to determine when to provide power to the heating element. “Thermostat” as used herein can refer to any controller which switches power on or off to the heating element based upon preset conditions, and need not be only based upon temperature.

In embodiments, the battery can be housed in a waterproof container, or stored within the liquid impermeable outer wall. In embodiments, the battery can be hung from the structure.

In embodiments, an inner wall can be utilized in conjunction with the liquid impermeable outer wall and insulating layer (if a separate insulating layer is used). The inner wall can act to protect the heating element, and the inner wall can also act to protect the structure by preventing direct contact with the heating element.

A typical use case is as follows: A backflow prevention structure is located in a remote area. Typically maintenance personnel do not frequent this area or it is an inconvenient location to access. The backflow prevention structure is exposed to the elements and often is subject to freezing temperatures. A burst valve or pipe due to liquid freezing within the backflow prevention structure would cause a significant burden to fix.

The liquid impermeable outer wall having an insulating layer and a heating element is placed over the backflow prevention structure. A waterproof case having a battery is hung on the piping of the backflow prevention structure. A solar panel is placed outside the liquid impermeable outer wall in a location exposed to sunlight. The solar panel is in mechanical communication with the battery and recharges the battery as needed and when sunlight is available. The power supplied by the battery can be controlled by a thermostat and switched on or off as needed when based upon environmental conditions.

In this manner, sufficient heat can be generated and provided to the backflow prevention structure to avoid freezing and a catastrophic failure of the equipment.

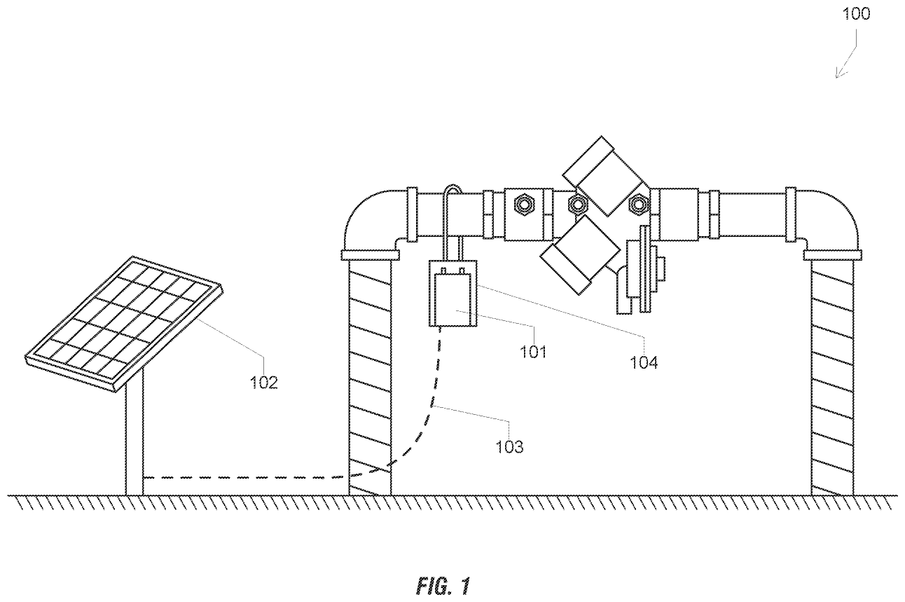

Turning now to the figures, FIG. 1 shows profile view of a structure 100 containing pipes, gauges, sensors, tools, and the like. It is desirable to prevent structure 100 from dropping to low temperatures.

A power source such as a battery 101 controlled by a thermostat (not shown) can be charged by a power source 102 in electronic communication with the battery 101 via a connection 103. In some embodiments, the thermostat can be a separate control device connected to the battery 101 to provide power to a heating element. The thermostat (or control device) can measure the ambient temperature or have other user defined parameters for when to power the heating element.

The battery 101 can be attached or placed near the structure by various means, such as a padlock to allow the battery to hang, attached to the structure using adhesive, or the battery 101 may be left unattached and placed nearby to the structure. The battery 101 can be rechargeable, exchangeable, and is encased in a water-resistant container 104 that may be attached to a fluid conveyance or is water resistant. In some embodiments the power source 102 can be a solar panel, electrical outlet, or any other power source known to persons having ordinary skill in the art.

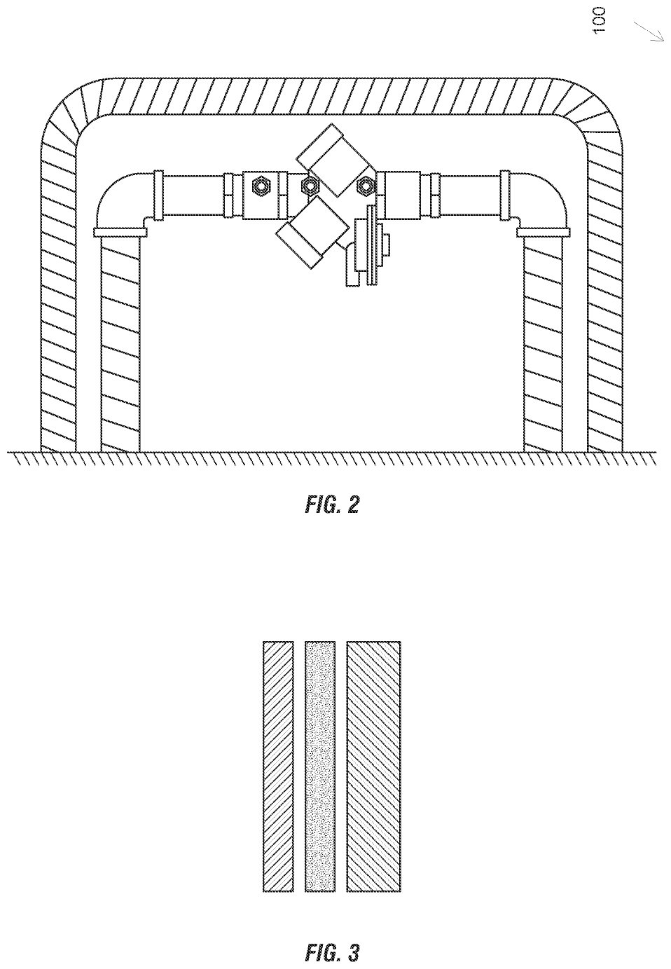

FIG. 2 depicts insulated cover 201 covering an exposed structure 100 of pipes, gauges, tools, and the like. In embodiments, the insulated cover 201 can be waterproof and windproof to protect the structure 100. The insulated cover 100 can be in multiple layers and comprise a heating element (not shown)

FIG. 3 depicts a sectional view of the insulated cover. In embodiments, the cover can be multiple layers.

The outer wall 301 can be a liquid impermeable wall made of plastic comprised of polyethylene, polyvinyl chloride, polypropylene or another type of material that can be suitable for controlling the internal environment and prevents or minimizes external environment influences, such as heat, moisture, wind, and the like from affecting the internal environment proximate the structure.

The insulating layer 302 can be both thermally and electrically insulating and may be comprised of fiberglass, rock wool, mineral wool, cellulose, natural fibers, polystyrene, polyisocyanurate, polyurethane, perlite, cementitious foam, phenolic foam, insulation facings, and the like.

The inner wall 303 can be comprised of the same material as the outer wall 301 or may be comprised of a different material and may protect the structure, the battery, the thermostat, the heating element, the like. In embodiments, the insulating layer and the inner wall can be the same item, i.e. one layer is used to insulate and act as the inner wall.

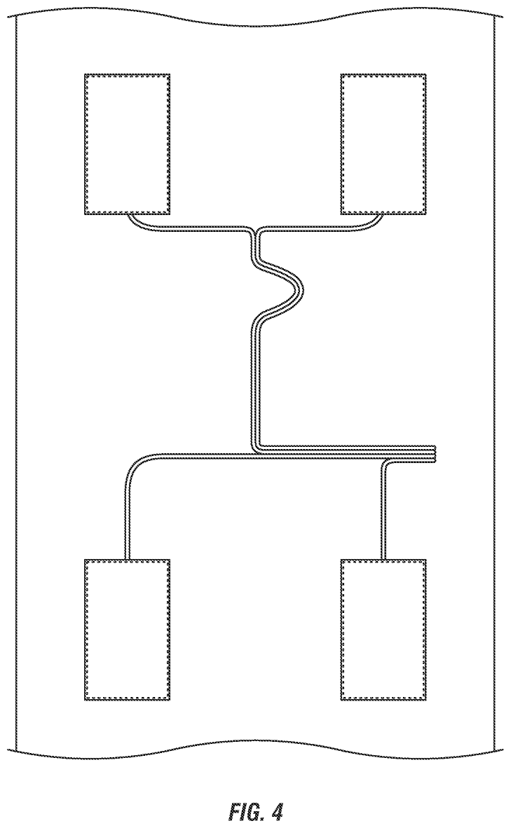

FIG. 4 depicts the heating element. Inner wall 303 can comprise a heating element 401 to be activated by the thermostat or other controller when specific conditions (such as extremely cold temperatures) occur. The heating element can be comprised of a flexible electrically conductive and thermally conductive material, such as copper wire, aluminum wire, or composite fiber. Further, the heating element can be connected to the battery, the power source, or both, to power the heating element with a thermostat or controller acting to switch the heating element on or off.

While the present disclosure emphasizes the presented embodiments and Figures, it should be understood that within the scope of the appended claims, the disclosure might be embodied other than as specifically enabled herein.

What is claimed is:

1. An insulated cover for exposed structure comprising:
a. a liquid impermeable outer wall;
b. an insulating layer;
c. a heating element;
d. a thermostat; and
e. a power source.

2. The insulated cover of claim 1, further comprising an inner wall.

3. The insulated cover of claim 1, wherein the heating element is a flexible electrically conductive and thermally conductive material.

4. The insulated cover of claim 1, wherein the heating element is copper wire, aluminum wire, or a composite fiber.

5. The insulated cover of claim 1, wherein the fluid impermeable outer wall comprises a plastic.

6. The insulated cover of claim 1, wherein the power source is a battery.

7. The insulated cover of claim 1, wherein the power source is a solar panel.

8. The insulated cover of claim 1, wherein the power source is a solar panel in conjunction with a battery.

9. The insulated cover of claim 1, wherein the heating element is copper infused thread attached to the fluid impermeable outer wall.

10. The insulated cover of claim 2, wherein the heating element is copper infused thread attached to the inner wall.

11. The insulated cover of claim 4, wherein the plastic comprises polyethylene, polyvinyl chloride, or polypropylene.

12. The insulated cover of claim 5, wherein the battery is rechargeable.

13. The insulated cover of claim 5, wherein the battery is housed in a water-resistant container.

14. The insulated cover of claim 11, wherein the water-resistant container is attachable to the fluid conveyance.
